(19) United States
(12) Patent Application Publication
(10) Pub. No.: US 2007/0006465 A1
(43) Pub. Date: Jan. 11, 2007

(54) Single-body sanitary spoon and chopsticks

(76) Inventor: Nan-Hee Lee, Gwangmyeong-si (KR)

Correspondence Address: LERNER GREENBERG STEMER LLP, P O BOX 2480, HOLLYWOOD, FL, 33022-2480, US

(21) Appl. No.: 11/347,851

(22) Filed: Feb. 6, 2006

(30) Foreign Application Priority Data
Jul. 6, 2005 (KR) 10 2005 0060723

(51) Int. Cl. B26B 3/00; B26B 11/00

(52) U.S. Cl. 30/142

(57) ABSTRACT

The present invention relates to one-body type for both sanitary spoon and chopsticks. The one-body type for both sanitary spoon and chopsticks of the present invention is consist of a left/right body as a pair of left spoon and right spoon, which is formed as bisection by the direction of up and down the spoon, and made of mixture of 75% up to 85% of polycarbonate (kind of synthetic resins) and 15% up to 25% of glass fiber; upper end connection part to be shaped as tongs to connect one-body type of the upper end of the left/right body; hinge part for non-crossing each other to be able to move smoothly the left/right body as formed at bottom end of the upper end connection part; a bottom end food contact part to be able to pick up and fill the food in the bottom of the left/right body with moving under of the hinge part; a sawtooth part as a shape of zigzag to go in gear with left side and right side each other to be not able to leak the food, which is formed in the bottom end food contact part; and a food holding part of the food as formed as a shape of projection on a central back side of as entire length of the upper end connection up to the bottom end food contact part, which is formed in below of the sawtooth.

### TECHNICAL FIELD

The present invention relates to one-body type for both sanitary spoon and chopsticks. The one-body type for both sanitary spoon and chopsticks of the present invention is consist of a left/right body as a pair of left spoon and right spoon, which is formed as bisection by the direction of up and down the spoon, and made of mixture of 75% up to 85% of polycarbonate (kind of synthetic resins) and 15% up to 25% of glass fiber; upper end connection part to be shaped as tongs to connect one-body type of the upper end of the left/right body; hinge part for non-crossing each other to be able to move smoothly the left/right body as formed at bottom end of the upper end connection part; a bottom end food contact part to be able to pick up and fill the food in the bottom of the left/right body with moving under of the hinge part; a sawtooth part as a shape of zigzag to go in gear with left side and right side each other to be not able to leak the food, which is formed in the bottom end food contact part; and a spoon holding part as formed as a shape of projection on a central back side of as entire length of the upper end connection up to the bottom end food contact part, which is formed in below of the sawtooth.

### BACKGROUND ART

The present invention relates to one-body type for both sanitary spoon and chopsticks. The present invention has a special feature that is made of mixture of 75% up to 85% of polycarbonate (kind of synthetic resins) and 15% up to 25% of glass fiber so that the shape is not change even if it refrigerate and boil water, is not stained with the color of the food, is possible to use as moving smoothly by using hinge part in upper end of the spoon, is not leaked the food because a sawtooth part is non-crossing each other, and a spoon holding part and sawtooth part is not touching on a table when the spoon is set down on the table.

In a typical one-body type for spoon and chopsticks in prior art, a problem was that the typical one-body type for spoon and chopsticks was inconvenient to use because of a gap and crossing each other when the food was picked up. Another problem was that using the typical one-body type for spoon and chopsticks, it was hard to use with user's fingers in use because the typical one-body type for spoon and chopsticks was made of strong quality of material having elasticity for preventing to change the external form of it in prior art. One another problem was that the typical one-body type for spoon and chopsticks stained with the color of the food in case of a strong color of the food such as kim-chi in Korea and curry. One another problem was that it was not possible to disinfect by boil water because the shape of the spoon was changed in boil water. One another problem was that both the spoon and table could be messy concerning for sanitation when setting down the spoon on the table.

As FIG. 1A shows a front view of a typical one-body type for both spoon and chopsticks when the spoon was closed according to the prior art, the problem was that it was inconvenient to pick up and put a food on the spoon because a left/right spoon was crossing each other inside of upper end of a food contact part (10) or bottom end of a left/right connector (20) of the spoon was not connected but it was formed as a curve. As FIG. 1b showed a side view of a typical one-body type for both spoon and chopsticks when the spoon was set down on a table according to the prior art, the problem was that both the food contact part (10) of the spoon and the table touched each other, so both the food contact part (10) of the spoon and the table could be messy concerning for sanitation.

### DISCLOSURE OF INVENTION

An object of the present invention for overcoming the above-mentioned problems is to provide a sanitary spoon to be able to disinfect by boil water or refrigeration, also provides unchanged shape although boiling and refrigerating the spoon because the spoon of the present invention is made of mixture of 75% up to 85% of polycarbonate (kind of synthetic resins) and 15% up to 25% of glass fiber.

Another object of the present invention provides one-body type for both sanitary spoon and chopsticks, which is not to be overstrained with user's fingers because it is easy to use with little grasping power, also a bottom end food contact part is non-crossing each other when left/right sides of the spoon are pushed because the spoon is formed a hinge part at a bottom of the upper connector, and also the bottom end food contact part and a spoon holding part are connected as the same line when the food is picked up using the bottom end food contact part.

The other object of the present invention is to provide one-body type for both sanitary spoon and chopsticks, which is not to touch between a bottom end food contact part and a table when the spoon is set down on the table.

### ADVANTAGEOUS EFFECTS

The present invention has an effect to provide unchanged shape although boiling the spoon due to its elasticity, to be able to disinfect by boiling the spoon, to be able to use and keep clean because it is not stained with the color of the food and not become dirty due to its smart design, is made of mixture of 75% up to 85% of polycarbonate and 15% up to 25% of glass fiber.

The present invention has another effect that from bottom end food contact part to spoon holding part is able to connect to be balanced when a user picks up the food using by the bottom end food contact part, prevent to leak the food due to non-crossing each other of the bottom food contact part when left side and right side of the spoon is pushed as formed a hinge part in the bottom of the upper connection part, and is not to be overstrained with user's fingers without inconvenience because it is easy to use with little grasping power.

The present invention has one another effect that it dose not matter with user's age and the thickness of user's fingers, make possible to use easily, so the user can use both hands and can make the user familiar with how to use the chopsticks.

The present invention has the other effect that it provides one-body type for both sanitary spoon and chopsticks so that it is not to touch between a bottom end food contact part and a table to keep clean when the spoon is set down on the table.

### BRIEF DESCRIPTION OF THE DRAWINGS

The present invention will become better understand with reference to accompanying drawings which are given only by way of illustration and thus are not limitative of the present invention, wherein;

FIGS. 1A and 1B are an isometric front view of a typical one-body type for both spoon and chopsticks according to the prior art.

FIG. 2 is a perspective view showing the one-body type for both sanitary spoon and chopsticks according to the present invention.

FIGS. 3A and 3B are a front view showing the one-body type for both sanitary spoon and chopsticks according to the present invention.

FIG. 4 is a rear view showing the one-body type for both sanitary spoon and chopsticks according to the present invention.

FIG. 5 is a side view showing the one-body type for both sanitary spoon and chopsticks according to the present invention.

FIG. 6 is another isometric view illustrating a modified version of the one-body type for both sanitary spoon and chopsticks according to the present invention.

FIG. 7 is one another isometric view illustrating a modified version of the one-body type for both sanitary spoon and chopsticks according to the present invention.

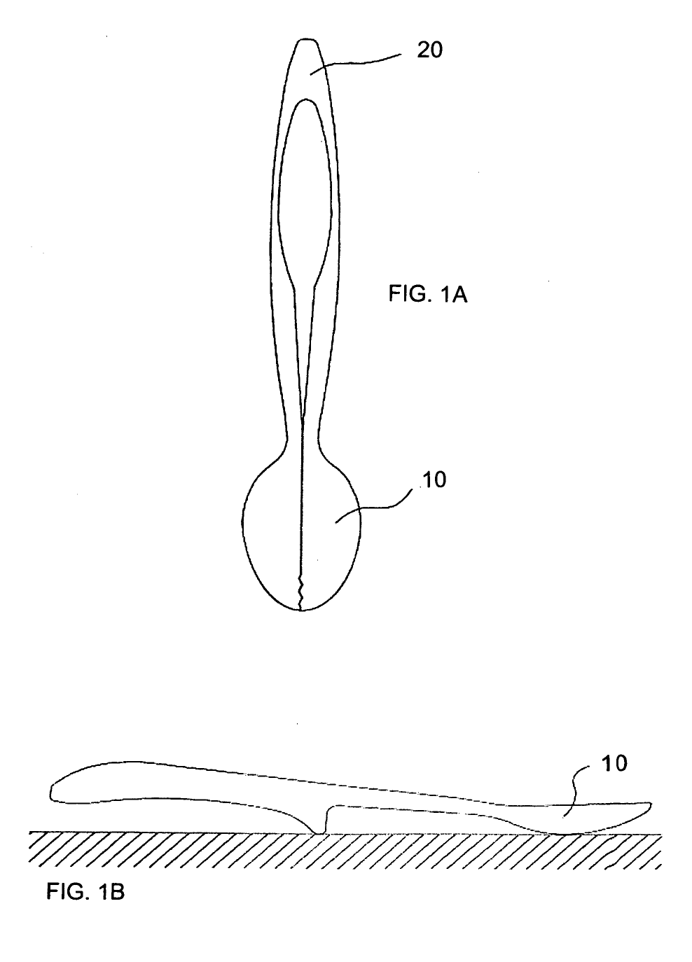

### BEST MODE FOR CARRYING OUT THE INVENTION MODE FOR THE INVENTION

The present invention for achievement of the above-mentioned objects is made of mixture of 80% of polycarbonate and 20% of glass fiber, and a left/right body (100) as a pair of left spoon and right spoon, which is formed as bisection by the direction of up and down the spoon; upper end connection part (110) to be shaped as tongs to connect one-body type of the upper end of the left/right body; hinge part (120) for non-crossing each other to be able to move smoothly the left/right body as formed at bottom end of the upper end connection part; a bottom end food contact part (130) to be able to pick up and fill the food in the bottom of the left/right body with moving under of the hinge part; a sawtooth part (140) as a shape of zigzag to go in gear with left side and right side each other to be not able to leak the food, which is formed in the bottom end food contact part; and a spoon holding part (150) as formed as a shape of projection on a central back side of as entire length of the upper end connection up to the bottom end food contact part, which is formed in below of the sawtooth.

From the spoon holding part (150) to the upper end connection part is more narrow in width and thicker a thickness of a front/back than from the spoon holding part (150) to the bottom end food contact part (130) so that it can be used as ordinary chopsticks, and easy to use, and also can still use ordinary chopsticks due to preventing to be set back of technique of using chopsticks although using the one-type spoon of the present invention for a long time.

The one-body type for both sanitary spoon and chopsticks of the present invention is made of mixture of 75% up to 85% of polycarbonate (kind of synthetic resins) and 15% up to 25% of glass fiber, the best mixing rate is 8:2 of the polycarbonate and the glass fiber.

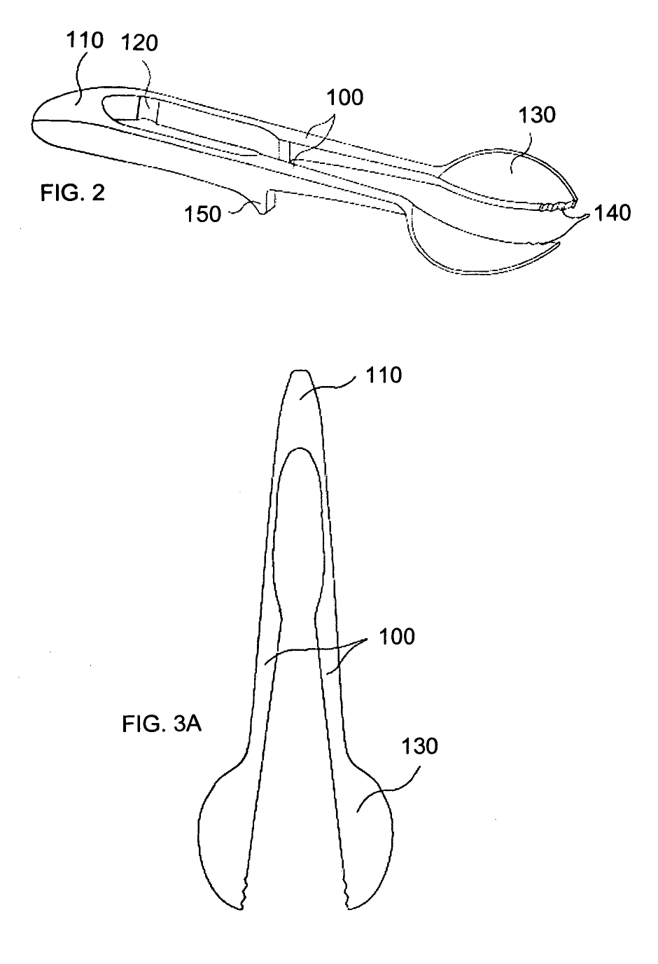

FIG. 2 is a perspective view showing the one-body type for both sanitary spoon and chopsticks according to the present invention. In details of the FIG. 2, the spoon is made of mixture of 75% up to 85% of polycarbonate and 15% up to 25% of glass fiber, and a left/right body (100) as a pair of left spoon and right spoon, which is formed as bisection by the direction of up and down the spoon; upper end connection part (110) to be shaped as tongs to connect one-body type of the upper end of the left/right body; hinge part (120) for non-crossing each other to be able to move smoothly the left/right body as formed at bottom end of the upper end connection part; a bottom end food contact part (130) to be able to pick up and fill the food in the bottom of the left/right body with moving under of the hinge part; a sawtooth part (140) as a shape of zigzag to go in gear with left side and right side each other to be not able to leak the food, which is formed in the bottom end food contact part; and a spoon holding part (150) as formed as a shape of projection on a central back side of as entire length of the upper end connection up to the bottom end food contact part, which is formed in below of the sawtooth.

The hinge part (120) is shaped as a hollow concave in backside view of the left/right body (100) but is not shaped as a hollow concave in front view of the left/right body (100), width of both sides is shaped as little by little wider from starting of the hinge part (120) to the spoon holding part (150), the hinge part (120) in the upper end part of the left/right body (100) is interacted as a bending point so that it is easy to use with little grasping power and non-crossing each other without inconvenience.

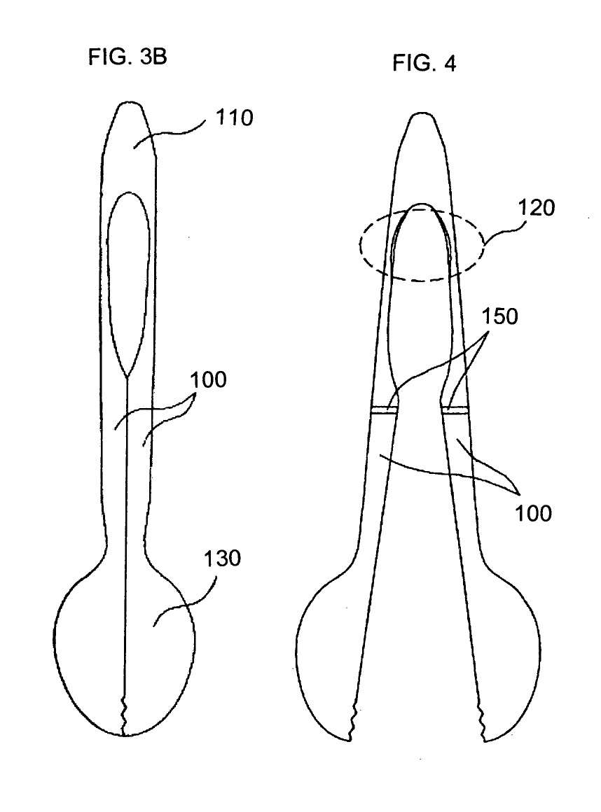

FIGS. 3A and 3B are a front view showing the one-body type for both sanitary spoon and chopsticks according to the present invention. If the left/right body (100) gets wider in both sides (FIG. 3a), the bottom of the left/right body is wider than its upper. If a user put and pick up the food using by the bottom end food contact part (130), the bottom of the left/right body is narrower than upper of the left/right body. Inside of the range from the spoon holding part (150, Not shown in FIG. 3b) to the bottom end food contact part (130) is connected as the same line so that the left spoon and right spoon of the left/right body is non-crossing each other. Thus, using the spoon of the present invention, it is convenient and natural as using ordinary separate chopsticks, and also the one-body type for both sanitary spoon and chopsticks of the present invention designed for a user who needs to learn how to use the chopsticks.

FIG. 4 is a rear view showing the one-body type for both sanitary spoon and chopsticks according to the present invention. In more details of the FIG. 4, a hinge part (120) in which the one-body type for both sanitary spoon and chopsticks according to the present invention makes possible to use smoothly and not to be non-crossing each other in picking up the food. The hinge part (120) is located at the same height of inside in face each other of left spoon and right spoon from left/right body (100), and is shaped as a hollow concave in backside view of the left/right body (100). The bottom part of the spoon holding part (150) designed as flat so that a user can set down the spoon safely and sanitarily on a table.

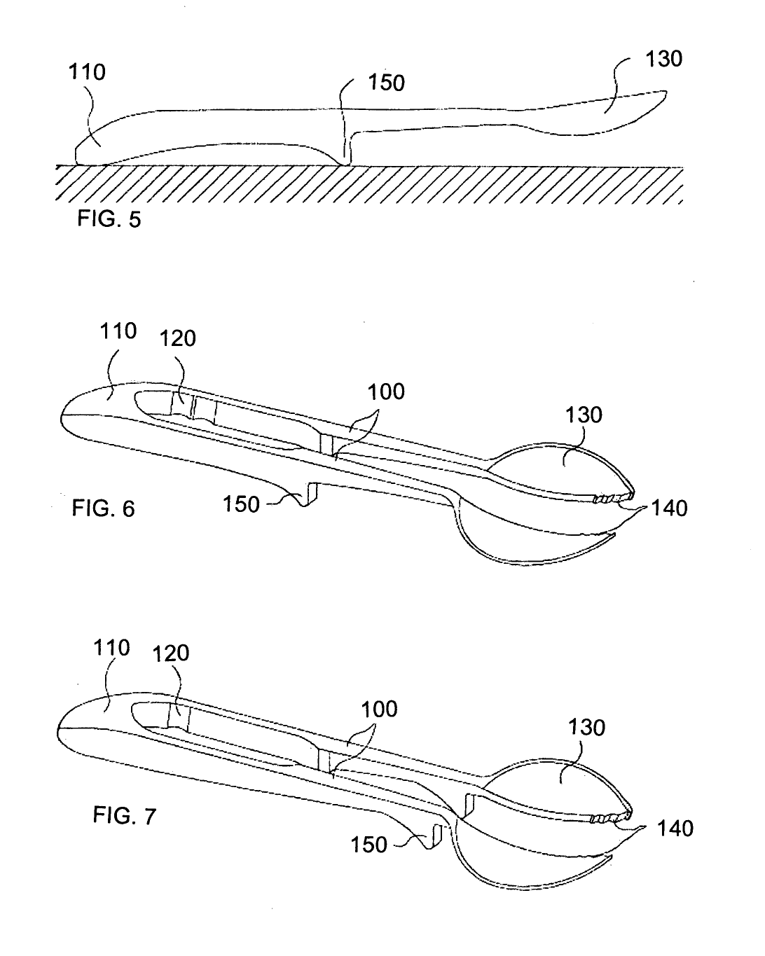

FIG. 5 is a side view showing the one-body type for both sanitary spoon and chopsticks according to the present invention. It is sanitarily great to use the spoon of the present invention because it is designed to be able to prevent to touch each other both the table and the bottom end food contact part (130) to keep clean, but the spoon holing part (150) and the upper connection part (110) is touched on the table when the spoon is put on the table, that is possible because the weight of the upper end connection part (110) is heavier than the bottom end food contact part (130) in a basis of the spoon holding part (150).

FIG. 6 and FIG. 7 are another isometric view illustrating a modified version of the one-body type for both sanitary spoon and chopsticks according to the present invention. The spoon holding part (150) is shaped as modified in the position of middle or bottom of backside of the left/right body (100). The hinge part (120) is formed as modified such as connect two of the hinge part as the same size in the bottom end of left/right body (100). As shown FIG. 7, the thickness in the direction of front/backside of the length from the upper end of left/right body (100) to the upper end of spoon holding part (150) is little by little narrower from the upper end to the bottom end when it is located and formed in the bottom of backside of the left/right body (100) the position of the spoon holding part (150).

The present invention is not limited to the above embodiment. As the present invention may be embodied in several forms without departing from the spirit or essential characteristics thereof, it should also be understood that the above-described examples are mot limited by any of the details of the foregoing description, unless otherwise specified, but rather should be constructed broadly within its spirit and scope as defined in the appended claims, and therefore all changes and modifications that fall within the meets and bounds of the claims, or equivalences of such meets and bounds are therefore intended to be embraced by the appended claims.

1. Single-body sanitary spoon and chopsticks assembly, comprising:
a left/right body means for a pair of left spoon and right spoon in which is formed as bisection by the direction of up and down the spoon, and made of mixture rate of 75% up to 85% of polycarbonate and 15% up to 25% of glass fiber;
an upper end connection part means being shaped as tongs to connect in one-body type of the upper end of the left/right body;
a hinge part means for non-crossing each other in which is able to move smoothly the left/right body as formed at bottom end of the upper end connection part;
a bottom end food contact part means for picking up and filling foods in the bottom end of the left/right body with moving under of the hinge part;
a sawtooth part means being shaped as zigzag to go in gear with left side and right side each other to be not able to leak the food, which is formed in the bottom end food contact part;
a spoon holding part means being formed as a shape of projection on a central back side of as entire length of the upper end connection up to the bottom end food contact part, which is formed in below of the sawtooth; and
from the spoon holding part to the upper end connection part in which is little by little narrower a width of both sides and thicker a thickness of a front/back than from the spoon holding part to the bottom end food contact part.

2. The assembly according to claim 1, wherein said mixture rate of the left/right body means rates at 80% of the polycarbonate and 20% of the glass fiber.

3. The assembly according to claim 1, wherein said left/right body in which between bottom ends of the left/right body is little by little wider than between upper ends of the left/right body when the left/right body get wider, and between the bottom ends of the left/right body is little by little narrower than between the upper ends of the left/right body when picking up and put foods using by the bottom food contact part.

4. The assembly according to claim 1, wherein said hinge part in which is located at the same height of inside in face each other of left spoon and right spoon from the left/right body, and is shaped as a hollow concave in backside view of the left/right body.

5. The assembly according to claim 1, wherein said hinge part in which can be modified as connecting two of the hinge part as the same size in the left/right body of a bottom end of the upper end connection part.

6. The assembly according to claim 1, wherein said one-body type for both sanitary spoon and chopsticks means includes inside of the bottom end food contact part and the spoon holding part is connected as the same line when the food is picked up using the bottom end food contact part so that a left spoon and a right spoon of the left/right body is non-crossing each other.

7. The assembly according to claim 1, wherein said spoon holding part in which can be modified as formed as a position in a middle or a bottom of backside of the left/right body.

8. The assembly according to claim 1, wherein said one-body type for both sanitary spoon and chopsticks means includes that is designed to be able to prevent to touch each other both the table and the bottom end food contact part to keep clean, but the spoon holing part, and the upper connection part is touched on the table when the spoon is set on the table, that is possible because the weight of the upper end connection part is heavier than the bottom end food contact part in a basis of the spoon holding part.
